(19) United States
(12) Patent Application Publication
(10) Pub. No.: US 2005/0036788 A1
(43) Pub. Date: Feb. 17, 2005

(54) Optical network system construction method and support system

(76) Inventors: Tadashi Matsuoka, Yokohama (JP); Junya Kosaka, Yokohama (JP); Yoshihiro Sugeta, Yokohama (JP)

Correspondence Address: MCDERMOTT WILL & EMERY LLP, 600 13th Street, N.W., Washington, DC, 20005-3096, US

(21) Appl. No.: 10/857,348

(22) Filed: Jun. 1, 2004

(30) Foreign Application Priority Data
Jun. 4, 2003 (JP) 2003-159066

(51) Int. Cl. H04J 14/02

(52) U.S. Cl. 398/81

(57) ABSTRACT

A method for constructing an optical network system and a support system which acquire, for optical fibers and the parts of repeater equipment which serve as the components of the optical network, characteristic data through actual measurement from components used actually in the network, perform simulation based on the measurement data, and determine a configuration of the repeater equipment to be placed at each of sites.

### CLAIM OF PRIORITY

The present application claims priority from Japanese application serial No. 2003-159066, filed on Jun. 4, 2003, the content of which is hereby incorporated by reference into this application.

### BACKGROUND OF THE INVENTION

(1) Field of the Invention

The present invention relates to a method for constructing an optical network system and a support system therefor and, more particularly, to a method for constructing a wavelength-division-multiplexing (WDM) optical network system and a support system therefor.

(2) Description of Related Art

As an IP (Internet Protocol) network as a social infrastructure has been used in a wider range, there has been a growing demand for backbone networks for high-speed optical communication. Vendors who design and vend communication network facilities are required to promptly install an optimum network system at low cost and immediately operate the installed system in response to requests from communication agencies (carriers) who order these backbone networks. This is because, if the period from the ordering of the system to the operation thereof can be reduced, the carrier is allowed to timely provide communication service to clients without missing a business chance and thereby recover investment on the facilities.

To rapidly construct and operate a communication network system at low cost, it is essential for the vendor to prepare communication equipment of sufficient and necessary types which can be optimally customized to a network configuration assumed by the carrier and establish a system which allows completion of construction and an adjustment operation in the field (site) in which the network is installed in a shortest possible period.

FIG. 2 shows, by way of example, a configuration of an optical backbone network in North America.

To increase the signal transmission capacity of an individual optical fiber, wavelength division multiplexing (WDM) transmission which multiplexes a plurality of optical signals at different wavelengths on the single fiber has been applied to the optical network system. However, the transmission characteristics of the optical signals on the optical fiber differ depending on the wavelength of signal light and a maximum transmission distance also differs depending on the wavelength of signal light. To guarantee the quality of a signal transmitted over the optical network, therefore, it is necessary to arrange signal repeater sites at intervals of every 200 to 300 km or. 500 km at most in accordance with a wavelength having a shortest transmission distance limit and perform a complicated repeating process (hereinafter referred to as regenerative repeating) of converting received optical signals to electric signals at each of the arranged sites, conducting shaping, regenerating, and the like with respect to the electric signals, converting the electric signals to optical signals again, and then transferring the optical signals to the next section.

In FIG. 2, the bold line represents an optical-fiber transmission path and the hollow circles and black-and-white double circles represent signal regeneration repeater sites at which repeater equipment or end terminal equipment is placed. By regeneratively repeating optical signals at each of these sites, a large-scale optical network system covering principal cities in North America has been constructed. It is to be noted that the depiction of repeater equipment having a simple configuration (hereinafter referred to as optical line amplifier equipment) which optically amplifies and repeats multiplexed received optical signals is omitted in FIG. 2.

As described above, the optical network system has the optical fibers forming a transmission path and optical signal transmission equipment including the optical line amplifier equipment and the signal regenerative repeater equipment which are placed at the repeater sites for optical signals as basic components. As an exemplary technology for constructing a long-haul optical network connecting optical fibers in a plurality of sections in cascade, Japanese Laid-Open Patent Publication No. HEI 8-201860 discloses one which calculates an average value of group velocity delay (dispersion) values for a plurality of optical fibers, classifies the optical fibers in accordance with deviations from the average value, connects the optical fibers in an order which minimizes an integral value of the group velocity dispersion, and thereby stabilizes the soliton transmission characteristic.

In a long-haul optical network having a configuration in which optical fibers in a plurality of sections are connected in cascade as shown in FIG. 2, it has been conventional practice to determine a position at which regenerative repeater equipment is to be placed based on an optical signal having a worst characteristic over the entire network, i.e., light at a wavelength having a shortest transmission distance limit, with a view to ensuring the reliability of wavelength-division-multiplexed transmitted signals at all wavelengths. As the total length of the installed optical fibers increases, the number of the regenerative repeaters increases accordingly. What results is a high-cost system configuration which receives quality compensation more than necessary in the course of transmission when viewed from an optical signal having a long transmission distance limit.

In the case where both optical fibers and optical signal transmission equipment are newly introduced in constructing or expanding the optical network system, it is possible to select the optical fibers and customize the transmission equipment in consideration of the respective product specifications thereof such that highest performance is obtained eventually. In this case, the design of a network system desired by a carrier is easy and the operation of adjusting the transmission equipment after the installation of the optical fibers can be performed relatively easily if the number of items of the regenerative repeater equipment is not considered.

In the field of an optical backbone network in which a transmission path is installed over a wide range, however, there are often cases where optical fibers already installed in transmission sections are used not only when the system is expanded or up-graded but also when a new network system is constructed. The optical fibers already installed and currently in an out-of-use state are generally termed dark fibers. There has been a recent tendency towards the opening of the dark fibers by a communication agency (primary carrier) having sufficient resources to another communication agency (secondary carrier).

Because the dark fibers are different in the times at which they were installed depending on areas and in manufacturers and manufacturing lots, the transmission characteristic of an optical signal differs from one transmission section to another. In addition, even optical fibers manufactured under the same standard have a slight performance difference therebetween due to variations in the composition of a raw material or in manufacturing process. In the case of constructing a new optical network system by using dark fibers, it is therefore necessary to determine transmission equipment to be placed at each of the repeater sites in accordance with the characteristics of the dark fibers to be used.

Although the characteristics of the dark fibers can be checked in a catalog offered by the manufacturer of the fibers or the like, there is an unnegligible difference between characteristic values (nominal values) given as catalog information and the performance of actually installed optical fibers. If the transmission equipment at each of the sites is selected based on the nominal values, there are often cases where the completed network system does not have characteristics as designed. If a network system is designed based on the nominal values, therefore, the resultant system configuration has a large performance margin in which items of the regenerative repeater equipment are arranged at short intervals in preparation for the occurrence of a worst case. Moreover, since it is necessary to assume an adjustment operation at each of the sites in the management of the process of placement operation, it becomes difficult to satisfy a request for low-cost and prompt system operation from the carrier.

Some vendors have adopted a method for introducing an optical transmission system which omits the optimization of repeater equipment depending on optical fibers to be used, places transmission equipment of standard specifications at each of the sites, and replaces the equipment depending on a situation in a fiber section. In a large-scale optical network having numerous items of repeater equipment connected in multiple stages between items of end terminal equipment, however, the method of placing the transmission equipment of standard specifications at the repeater sites requires time to check signal quality at each of the sites and determine the transmission equipment to be replaced so that an extremely inefficient adjustment operation is needed eventually.

### SUMMARY OF THE INVENTION

An object of the present invention is to provide a method for constructing an optical network system and a support system therefor capable of extending an inter-repeater section over which optical signals can be repeated by using optical line amplifier equipment.

Another object of the present invention is to provide a method for constructing a low-cost optical network system and a support system therefor which allow a reduction in the number of regenerative repeater equipment.

Still another object of the present invention is to provide a method for constructing an optical network system and a support system therefor which allow rapid construction of an optical network system even when dark fibers are used.

To attain the foregoing objects, the present invention is characterized in that it acquires characteristic data on each of the components of the optical network system through measurement of the components actually used in the network, performs simulation based on the measurement data, and thereby determines a configuration of repeater equipment to be placed at each of the sites.

More specifically, according to the present invention, a method for constructing an optical network system composed of optical fibers in a plurality of sections and repeater equipment placed at each of sites located on boundaries between the sections, comprising: (A) a step of accumulating in a first memory, measured characteristic survey data on the optical fibers to be used in the individual sections, as fiber data associated with the sections; (B) a step of accumulating, in a second memory, measured characteristic survey data on plural kinds of parts serving as components of the repeater equipment, preparing a plurality of types having different characteristics for each of the kinds of parts, as part data corresponding to the respective kinds of parts; and (C) a simulation step of selecting the parts to be arranged at each of the sites on the optical network composed of the optical fibers in the plurality of sections by simulation performed on a computer by using the fiber data accumulated in the first memory and the part data accumulated in the second memory to determine a configuration of the repeater equipment placed at each of the sites.

By preparing, as the part data, characteristic data on, e.g., an optical amplifier, a fine adjustment part such as an optical attenuator, and a chromatic dispersion compensating module, it becomes possible to determine the configurations of optical line amplifier equipment to be placed at each of the sites. If characteristic data measured by a route survey from already installed optical fibers is used as the fiber data, an optical network system using existing dark fibers can be constructed.

As a characteristic aspect of the method for constructing an optical network system according to the present invention, the simulation step includes: generating a plurality of part arrangement patterns representing the parts to be arranged at the plurality of sites on the optical network by varying, on a per part kind basis, a combination of the types of parts to be used, and simulating a state of an optical signal when the parts are arranged at each of the sites according to each of the arrangement patterns and selecting, on a per part kind basis, that one of the part arrangement patterns which satisfies a given signal standard at a terminal end of the optical fiber in the final section to determine the configuration of the repeater equipment placed at each of the sites.

When simulation is thus performed in a state in which the parts have preliminarily been arranged at the plurality of sites on the optical network to be constructed, the overall signal transmission state of the optical network can be recognized. Accordingly, even though the state of the optical signal is under a desired standard at one of the sites on a signal path, it will be proved that signal repeating has no problem provided that specified standards are eventually satisfied at the terminal end of the network.

When the types of the parts serving as the components of the optical line amplifier equipment to be placed at the individual sites can be determined as a result of the foregoing simulation, it becomes possible to construct all the sites in sections to be constructed by using the optical line amplifier equipment and thereby reduce the number of optical regenerative repeater equipment to be placed.

As another characteristic aspect, the method for constructing an optical network system according to the present invention includes: a step of outputting, as optical network configuration information, a relationship between each of the sites and the configuration of the repeater equipment to be placed thereat determined in the simulation step.

If the optical network system configuration information outputted as the result of simulation is used, it becomes possible to easily perform, in the field, the operation of placing the repeater equipment at each of the sites and connect the adjacent optical fibers in succession. Since it is expected in accordance with the present invention that an optical signal satisfies specified standards at the terminal end of the network as a result of simulation based on data measured from the components, the operation of constructing the optical network system can be completed rapidly by performing an end-to-end signal test to check network performance in the optical network system the construction of which has been completed.

A system for supporting construction of an optical network system according to the present invention comprises: a first memory for accumulating measured characteristic survey data on the optical fibers to be installed in the individual sections as fiber data associated with the sections; a second memory for accumulating measured characteristic survey data on plural kinds of parts serving as components of the repeater equipment, preparing a plurality of types having different characteristics for each of the kinds of parts, as part data corresponding to the respective kinds of parts; a data processor for selecting the parts to be arranged at each of the sites on the optical network composed of the optical fibers in the plurality of sections, by executing a simulation program using the fiber data accumulated in the first memory and the part data accumulated in the second memory to determine a configuration of the repeater equipment placed at each of the sites; and an output device for outputting, as optical network configuration information, a relationship between each of the sites and the repeater equipment to be placed thereat obtained as a result of the simulation.

In the first memory, for example, the measured values of the length, optical loss, return characteristic, chromatic dispersion, polarization-mode dispersion of each of optical fiber sections are stored as the fiber data.

An optical amplifier used for an optical line amplifier equipment is normally controlled to have a given optical output level. The reason for this is that, if the optical output level is low, the S/N ratio of a signal deteriorates and, if the optical output level is excessively high, on the other hand, the signal deteriorates under the non-linear effect of a fiber. A loss occurring in an optical fiber varies depending on the characteristics of the fiber or a path length. If the loss value of the optical fiber is measured preliminarily, however, the input level of the optical signal at the next site can be calculated by controlling the optical amplifier at each of the sites such that it has a constant output level and the gain of the optical amplifier to be used can be determined.

The chromatic dispersion indicates the wavelength dependence of an optical propagation velocity in an optical fiber and the chromatic dispersion characteristic and the dispersion slope thereof differ depending on the length, type, and manufacturing lot of the optical fiber. Individual optical signals propagating through the optical fiber are composed of different polarized waves and the polarization-mode dispersion indicates variations in propagation velocity depending on the polarized waves. The polarization dispersion characteristic differs depending on the type, manufacturing lot, and installation state of the optical fiber. Since the chromatic dispersion and the polarization-mode dispersion substantially enlarge the width of a transmitted pulse and degrades the transmission characteristic, it is necessary to use a chromatic dispersion compensating module in each the repeater equipment in accordance with the chromatic dispersion and the polarization-mode dispersion each occurring in the optical fiber.

In installing an optical fiber, it is necessary to fuse connect fibers for the convenience of installation work or use an optical connector for the convenience of connection to repeater equipment. Consequently, various connection points exist in the individual optical fiber sections and optical return occurs at these connection points. When optical return occurs, it causes an excessive loss in apparent signal power, adversely affects the optical amplifier, or causes multiple return occurring between two reflection points to degrade the transmission characteristic. If an amount of measured return is excessively large, it is necessary to clean a reflecting surface and then measure the fiber characteristics again.

### BRIEF DESCRIPTION OF THE DRAWINGS

FIG. 1 is a flow chart showing the overall procedure of an optical network construction method according to the present invention;

FIG. 2 is a view showing an example of a configuration of an optical backbone network;

FIG. 3 is a view schematically showing a network configuration between sites A and D in the optical backbone network of FIG. 2;

FIG. 4 is a view showing a configuration of regenerative repeater equipment 6 in FIG. 3;

FIG. 5 is a view showing a configuration of an optical network constructed in accordance with the present invention, which corresponds to FIG. 3;

FIG. 6 is a view showing an example of optical line amplifier equipment 8 in FIG. 5;

FIGS. 7A to 7C are views each for illustrating a relationship between a gain slope generated in an amplifier 810 and a gain slope compensator 811;

FIG. 8 is a block diagram showing an embodiment of a simulator 10;

FIG. 9 is a view showing an example of DCF data 310 read in a DCF data file region 31;

FIG. 10 is a view showing an example of ATT data 320 read into an ATT data file region 32;

FIG. 11 is a view showing an example of optical amplifier data 330 read into an optical amplifier data file region 33;

FIG. 12 is a view showing an example of fiber data 410 read into a fiber data file region 41;

FIG. 13 is a flow chart showing an embodiment of a simulation program 200 executed by the processor 11 of the simulator 10;

FIG. 14 is a flow chart showing an embodiment of a DCF arrangement evaluation algorithm 220;

FIG. 15 is a flow chart showing an embodiment of an ATT arrangement evaluation algorithm 230;

FIG. 16 is a flow chart showing an embodiment of an optical amplifier arrangement evaluation algorithm 230; and

FIG. 17 is a view showing an embodiment of a DCF arrangement pattern table 510.

### DETAILED DESCRIPTION OF PREFERRED EMBODIMENTS

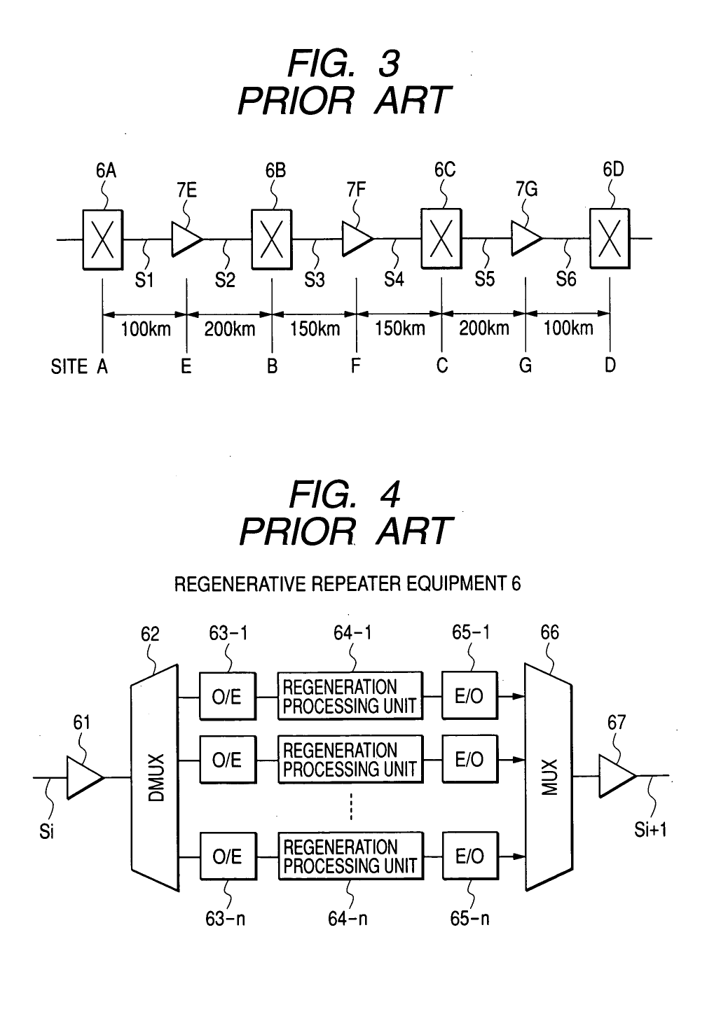

Referring to the drawings, the embodiments of the present invention will be described herein below. For easier understanding of the present invention, a description will be given first to a conventional optical network construction method with reference to FIGS. 3 and 4.

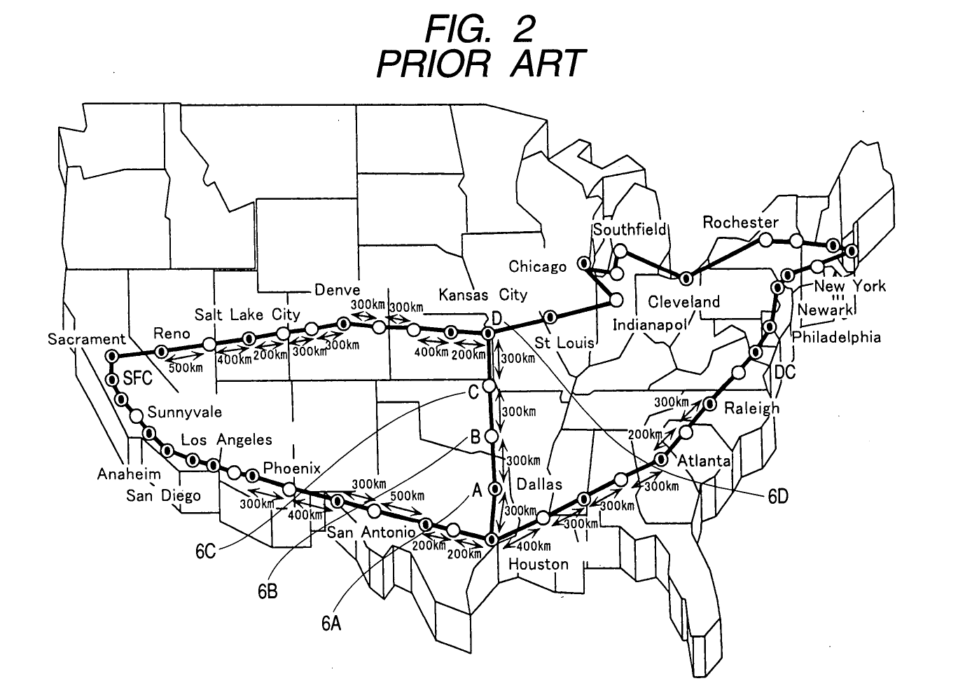

FIG. 3 schematically shows a network configuration between respective sites A and D at which regenerative repeater equipment 6A and regenerative repeater equipment 6B shown in FIG. 2 are placed. Between the sites A and D, sites B and C each having regenerative repeater equipment 6 (6B, 6C) are disposed. Between these sites of the regenerative repeater equipment, sites E to G each having optical line amplifier equipment 7 (7E to 7G) are further disposed, though the depiction thereof is omitted in FIG. 2.

FIG. 4 shows a configuration of the regenerative repeater equipment 6 placed at each of the sites A to D.

Wavelength division multiplexed light which has been attenuated while being transmitted over an optical fiber Sᵢ is amplified by a received optical signal amplifier 61 and then demultiplexed into n trains of signal light each having a single wavelength by a wavelength demultiplexer 62. The individual trains of demultiplexed signal light at different wavelengths are converted to electric signals by using optical/electric converters (O/E) 63 (63-1 to 63-n), which are inputted to regeneration processing units 64 (64-1 to 64-n) and subjected to signal regeneration processing including waveform re-shaping and amplification. The electric signals outputted from the regeneration processing units 64 (64-1 to 64-n) are converted again to optical signals at different wavelengths by using electric/optical converters (E/O) 65 (65-1 to 65-n) and then multiplexed by a wavelength multiplexer 66. The wavelength division multiplexed light outputted from the wavelength multiplexer 66 is amplified by a transmission signal optical amplifier 67 to a specified output level and outputted to an optical fiber Sᵢ₊₁ in the subsequent section.

As is obvious from the foregoing configuration, the regenerative repeater equipment 6 has a complicated configuration which converts wavelength division multiplexed optical signals received from an optical fiber in the preceding section to respective single electric signals for each wavelength, performs the signal regeneration processing with respect to the electric signal, and then reconverts the electric signals to wavelength division multiplexed optical signals. As transmission of higher-density wavelength division multiplexed light becomes prevalent in near future, the number of signal processing circuits for different wavelengths is increased accordingly and equipment scale and cost are increased inevitably.

By contrast, the optical line amplifier equipment 7 placed at each of the sites E to G has a simple configuration including, as a main body, an optical amplifier device which amplifies a received optical signal as wavelength division multiplexed light. Accordingly, the optical line amplifier equipment 7 has significant advantages over the regenerative repeater equipment 6 in equipment scale, cost, placement space, and the like. In terms of the entire network system, if the number of items of the regenerative repeater equipment 6 can be reduced by extending an inter-repeater section by using the optical line amplifier equipment 7, a significant advantage is offered from the viewpoint of system cost.

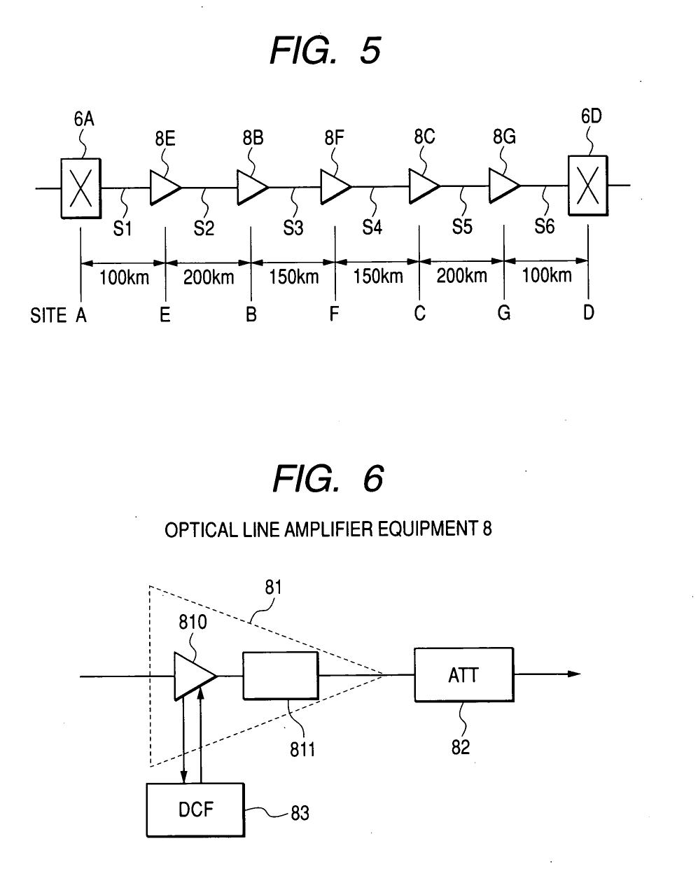

As shown in FIG. 5, the present invention provides an optical signal transmission system and a construction support system therefor in which the regenerative repeater equipment 6 (6B and 6C) that has been disposed between the sites A to D in the conventional optical network can be replaced with the optical line amplifier equipment 8 (8B and 8C) and the extension of the inter-repeater section using the optical line amplifier equipment is thereby allowed.

In order to extend the inter-repeater section by using the optical line amplifier equipment, in the present invention, the characteristics of the individual optical fibers Si (i=1 to 6) between the regenerative repeater equipment items 6A and 6D are measured and it is evaluated whether these fiber sections are appropriate for signal repeating using the optical line amplifier equipment by simulation. If possible, the optical line amplifier equipment items 8 (8E to 8G) are placed at all the sites, whereby the number of items of the regenerative repeater equipment 6 is reduced.

FIG. 6 shows an embodiment of the optical line amplifier equipment 8 used in the present embodiment.

The optical line amplifier equipment 8 is composed of: an optical amplifier 81 for amplifying an input optical signal from the input-side optical fiber Sᵢ to a specified output level; an optical attenuator (ATT) 82 for finely adjusting the signal level of wavelength division multiplexed signals outputted to the output-side optical fiber Sᵢ₊₁; and a dispersion compensating module (DCF) 83. The optical amplifier 81 is composed of an optical amplifier 810 and a gain slope compensator 811. The DCF 83 has been incorporated into the optical amplifier 810 via an I/O line 812.

For example, if an optical amplifier of EDFA type having a wavelength-dependent amplifier gain is used as the optical amplifier 810, gain flatness incurs inclination (gain slope) so that the level of an output optical signal differs with different wavelengths. In addition, the wavelength dependence of an optical loss occurring in the input-side optical fiber Sᵢ also causes the deterioration of gain flatness in the output optical signal from the optical amplifier 810. The gain slope compensator 811 is for compensating for the inclination (gain slope) of gain flatness caused by the foregoing factors in the output optical signal from the optical amplifier 810.

The present invention previously prepares plural types with different characteristics of each of parts such as the optical amplifier 81, the optical attenuator 82, and the DCF 83 and combines the parts compatible with the actually measured characteristics (optical loss, return, wavelength dispersion, polarization-mode dispersion, and the like) of optical fibers S1 to S6 to constitute the optical line amplifier equipment 8 at each of the sites such that an input optical signal at the final site D satisfies an objective standard.

The types of the optical amplifier 81 and the optical attenuator (ATT) 82 to be arranged at the sites E to G are selectively determined in a combination which allows the input optical signal at the final site D to reach the objective level in accordance with an amount of optical loss occurring in each of the optical fibers S1 to S6. The dispersion compensating module (DCF) 83 is for compensating for the distortion of the optical signal caused by chromatic dispersion or polarization-mode dispersion during the propagation of the optical signal. The dispersion compensating module 83 is selected based on the chromatic dispersion characteristics and polarization-mode dispersion characteristics of the optical fibers S1 to S6. As the optical amplifier 81, an amplifier comprising a gain slope compensator 811 with a gain flatness of +0.2 dB/nm, e.g., is used at a position at which a gain slope of −0.2 dB/nm occurs in an output optical signal from the amplifier 810, whereby the signal levels at the different wavelengths of the multiplexed optical signal are made uniform.

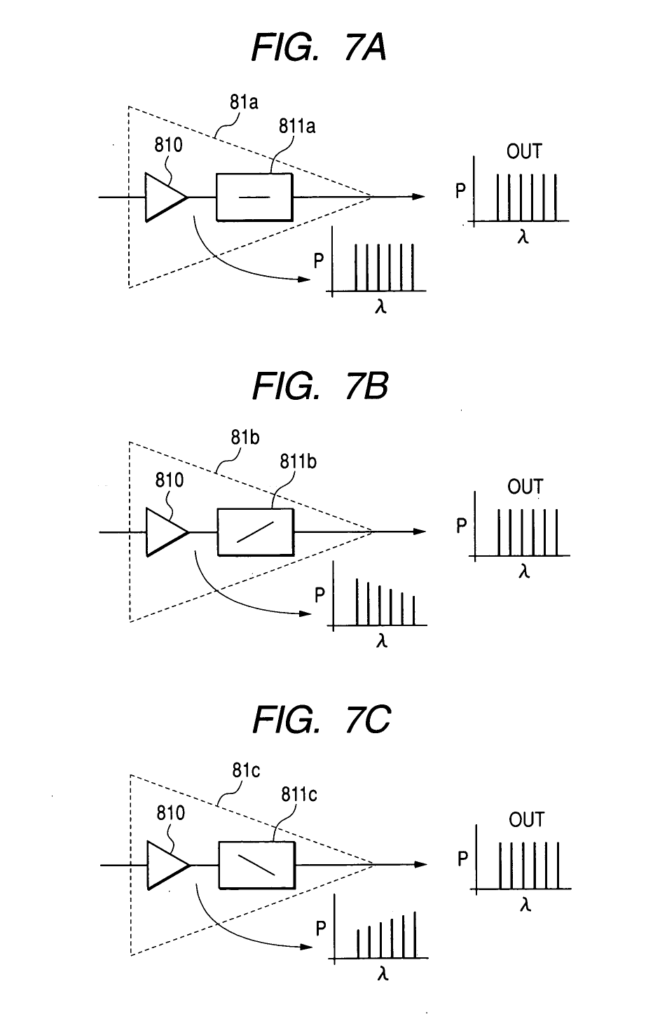

FIGS. 7A to 7C show a relationship between a gain slope occurring in output signals from the amplifier 810 and the characteristics of the gain slope compensator 811.

FIG. 7A shows the case where a gain slope compensator 811a having gain flatness with no inclination is used because the output signal gain P of the amplifier 810 is flat over all the multiplexed wavelengths λ. FIG. 7B shows the case where a gain slope compensator 811b having gain flatness with a plus inclination characteristic because the output signal gain P of the amplifier 810 has a gain slope with a minus characteristic which deteriorates gradually toward higher wavelengths. FIG. 7C shows the case where a gain slope compensator 811c having gain flatness with a minus inclination characteristic is used because the output signal gain P of the amplifier 810 has a gain slope with a plus characteristic which deteriorates gradually toward shorter wavelengths.

By thus using the gain slope compensator 811 in accordance with the characteristic of the gain slope occurring in the amplifier, a multiplexed optical output with a uniform gain over all the wavelengths can be obtained from the optical amplifier 81.

If the level of the optical output signal from the optical amplifier is low, the S/N ratio deteriorates due to plenty of noise. Conversely, if the optical output level is high, the signal deteriorates under the influence of a fiber non-linear effect such as four wave mixing. By retaining the gain flatness of the output signal from the optical amplifier, the gain slope compensator 811 can prevent signal deterioration due to the S/N deterioration or the non-linear effect at all the wavelengths and allows long-haul transmission of an optical signal.

The present invention is characterized in that it has extended the optical fiber section over which the signal can be repeated by using the optical line amplifier equipment 8 by optimizing the combination of the optical amplifier 81, the optical attenuator (ATT) 82 for fine adjustment, and the dispersion compensating module (DCF) 83 through simulation and thereby reduced the number of sites at which the regenerative repeater equipment is placed.

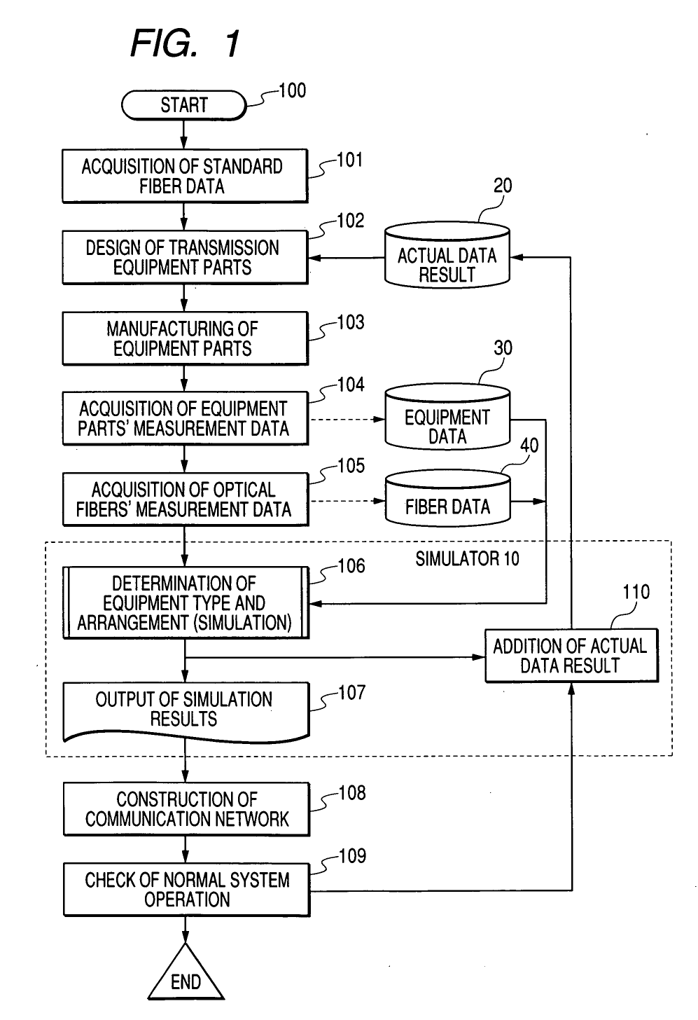

FIG. 1 shows an entire flow chart illustrating an optical network system construction method according to the present invention.

In the present embodiment, standard data on optical fibers to be used in the sections of an optical network to be constructed is acquired from a catalog or a specification table provided by a maker (Step 101). The optical fibers as the target of data acquisition are, e.g., S1 to S6 shown in FIG. 5. These optical fibers may be dark fibers already installed or optical fibers to be newly installed. The acquired standard data on the optical fibers include, e.g., the values of a transmission loss and chromatic dispersion indicative of the transmission characteristics of the individual optical fibers.

Next, parts composing the transmission equipment which are needed at each of the repeater sites are designed based on the standard data (102) and manufactured (103). The transmission equipment used in the present embodiment includes the optical line amplifier equipment 8 and the input unit of the regenerative repeater equipment at the final site (which is, e.g., 6D). The parts of the transmission equipment to be designed include the optical amplifier 81, optical attenuator (ATT) 82, and chromatic dispersion compensating module 83 of the optical line amplifier equipment 8 shown in FIG. 6, the received optical signal amplifier 61 of the regenerative repeater equipment shown in FIG. 4, and the dispersion compensating module (DCF) to be incorporated into the optical amplifier.

The present invention prepares plural types of each of the parts including standard parts optimized in accordance with the standard data and optional parts slightly different in characteristic from the standard parts such that a given range centering around the standard data is covered.

For example, a plurality of types are prepared as the optical amplifier 81 which are different in the combination of the gain (wavelength dependence) of the amplifier 810 and the gain slope compensator 811. As the optical attenuator 82, a plurality of types which are different in an amount of attenuation are prepared, while a plurality of types which are different in dispersion value are prepared as the dispersion compensating module 83. In simulation (106) which will be described later, the compatibilities of the parts at each of the repeater sites are evaluated under the assumption that plural types of parts are prepared and the configuration of the optical line amplifier equipment to be used is determined.

For example, it is assumed that, from the fiber standard data, five kinds (types) having different characteristics and in each of which the gain slope, the dispersion value, and an optimum value (standard value) of the amount of attenuation are “+2 dB/nm”, “100 ps/nm”, and “1.5 dB” are prepared for each of the parts. In this case, five types having respective gains slopes of “−2 dB/nm”, “0 dB/nm”, “+2 dB/nm”, “+4 dB/nm”, and “+6 dB/nm” are prepared as the optical amplifier 81 for the optical line amplifier equipment. As the dispersion compensating module 83, five types having respective dispersion values of “0 ps/nm”, “50 ps/nm”, “100 ps/nm”, “150 ps/nm”, and “200 ps/nm” are prepared. As the optical attenuator 82, five types having respective amounts of attenuation of “0.5 dB”, “1.0 dB”, “1.5 dB”, “2.0 dB”, and “2.5 dB” are prepared.

Since the received optical signal amplifier 61 of the regenerative repeater equipment is different from the optical amplifier 81 of the optical line amplifier equipment in restrictions on output level, a plurality of types different from those prepared for the optical amplifier 81 are prepared for use in the regenerative repeater equipment.

In determining the types of the parts, previous part data registered in an actual data file 20 is referenced and, needless to say, already existing parts are excluded from the targets of design and manufacturing. By thus preparing plural types of the parts having different characteristics, it becomes possible to facilitate simulation and rapidly construct an actual system based on the result of the simulation.

Next, data measured from equipment parts to be used for simulation is acquired (104). Although specification data on the individual parts is made known from the design values of the parts, actually manufactured parts have manufacturing errors and variations occurring in the manufacturing process so that, if the specification data on the individual parts is used without alterations as parameters for simulation, the accuracy of the simulation lowers to eventually cause a problem such as unachieved objective performance or a time-consuming adjustment operation in the field.

To prevent this, the present invention measures the characteristics of each of the manufactured parts to acquire actual characteristic data therefrom and accumulate the part data in an equipment data file 30. A given amount of modulus data is acquired for each of the parts, subjected to a statistic process if necessary, and then accumulated as characteristic data on the types of the part in the equipment data file 30 so that it is used as model data for simulation.

For the same reason, measured data on the characteristics of the optical fibers (S1 to S6) in the individual transmission sections, which serves as the components of the optical network, is also acquired and accumulated (105) in a fiber data file 40.

The present invention performs simulation on a simulator 10 by using the equipment data and the fiber data accumulated in the data files 30 and 40 and the previous actual data shown by the data file 20 as required, determines the configuration of the transmission equipment (optical line amplifier equipment) to be placed at each of the sites (106), and outputs it as the result of the simulation (107).

Since the result of the simulation specifies the types of the components 81 to 83 of the optical line amplifier equipment 8 to be used at the individual sites, it becomes possible to rapidly complete the construction of the network (108) by connecting the adjacent optical fibers with the equipment configuration in accordance with the result of the simulation. When the placement of the optical line amplifier equipment 8 is completed, the performance of the network is tested by using test signals, a fine adjustment operation is performed if necessary, and the normal operation of the system is checked (109). The result of the test is reflected on the actual data file 20 (110) and then on the subsequent system design.

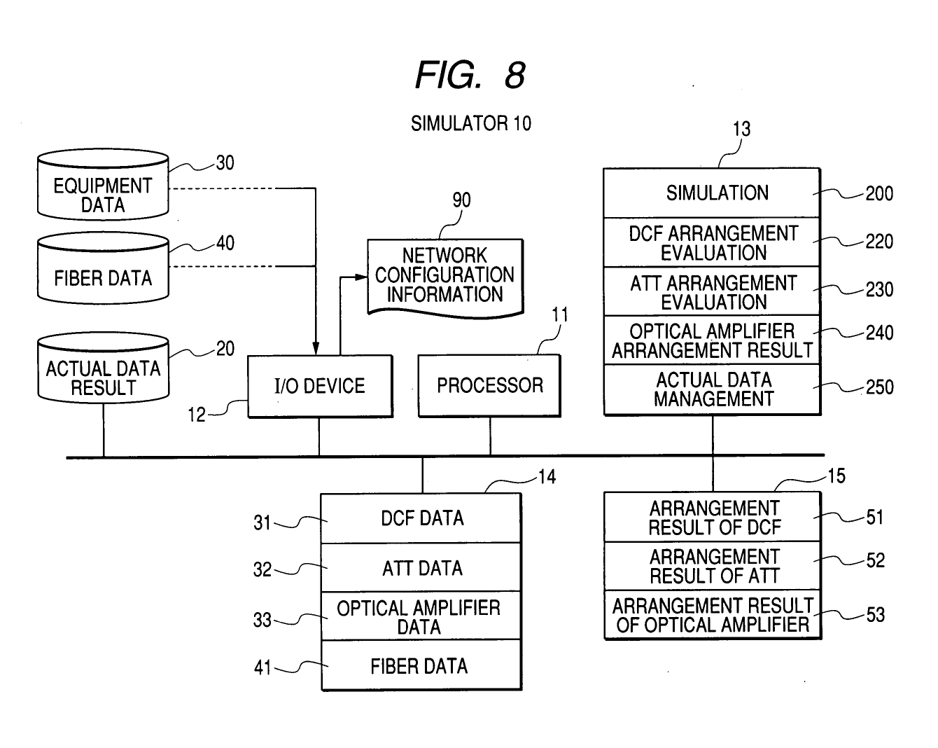

FIG. 8 is a block diagram showing an example of the simulator 10.

The simulator 10 is composed of: a processor (CPU) 11; an I/O device 12; a program memory 13 storing therein a simulation program to be executed by the processor 11; a memory 14 storing therein basic data for simulation; a data memory 15 storing therein data generated in the process of simulation; and the actual data file 20.

In the program memory 13, there are prepared: a simulation program 200; an arrangement evaluation algorithm 220 for a chromatic dispersion compensating module (hereinafter referred to as DCF); an arrangement evaluation algorithm 230 for an attenuator (hereinafter referred to as ATT) as a fine adjustment part; an arrangement evaluation algorithm 240 for an optical amplifier; and an actual data management routine 250.

The contents of the equipment data file 30 illustrated in FIG. 1 is read, on a per part basis, into the DCF data file region 31, ATT data file region 32, and optical amplifier data file region 33 of the memory 14 via the I/O device 12. The contents of the fiber data file 40 is read into the fiber data file region 41 of the memory 14.

Simulation is performed by using the part data and the fiber data each read into the memory 14. The result of DCF arrangement determined through the execution of the DCF evaluation algorithm 220 is stored as DCF arrangement result data 51 in the data memory 15. The result of ATT arrangement determined through the execution of the ATT arrangement evaluation algorithm 230 is stored as ATT arrangement result data 52 in the data memory 15. The result of optical amplifier arrangement determined through the execution of the optical amplifier arrangement evaluation algorithm 240 is stored as optical amplifier arrangement result data 53 in the data memory 1.5. The final result of simulation is registered in the actual data file 20 by the actual data management routine 250 and print outputted as a system configuration list 90 suitable for use in the operation of placing the transmission equipment.

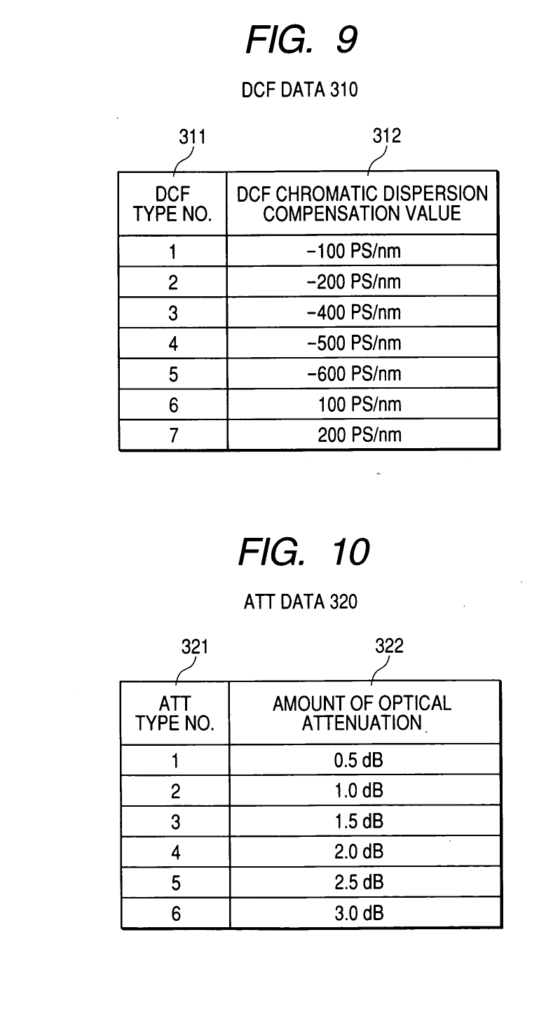

FIG. 9 shows an example of DCF data 310 read out from the equipment data file 30 into the DCF data file region 31. The DCF data 310 is comprised of a plurality of entries indicative of DCF chromatic dispersion compensation values 312 in correspondence to the DCF (chromatic dispersion compensating module) type numbers 311.

The DCF arrangement evaluation algorithm 220 determines, in accordance with a predetermined algorithm, DCF types to be arranged at the individual sites from among DCFs shown by the DCF data 310 according to a combination of factors such as the type, chromatic dispersion, and fiber length of each of the optical fibers (S1 to S6) used in the optical network.

FIG. 10 shows an example of the ATT data 320 read out from the equipment data file 30 into the ATT data file region 32. The ATT data 320 is comprised of a plurality of entries indicative of respective amounts of optical attenuation 322 in correspondence to ATT (optical attenuator) type numbers 321.

As described with reference to FIG. 8, the ATT (optical attenuator) 81 is disposed immediately after the optical amplifier 81. The ATT arrangement evaluation algorithm 230 determines, in accordance with a predetermined algorithm, ATT types to be arranged at the individual sites from among ATTs shown by the ATT data 320 according to a combination of factors such as the type, chromatic dispersion, and fiber length of each of the optical fibers (S1 to S6) used in the optical network.

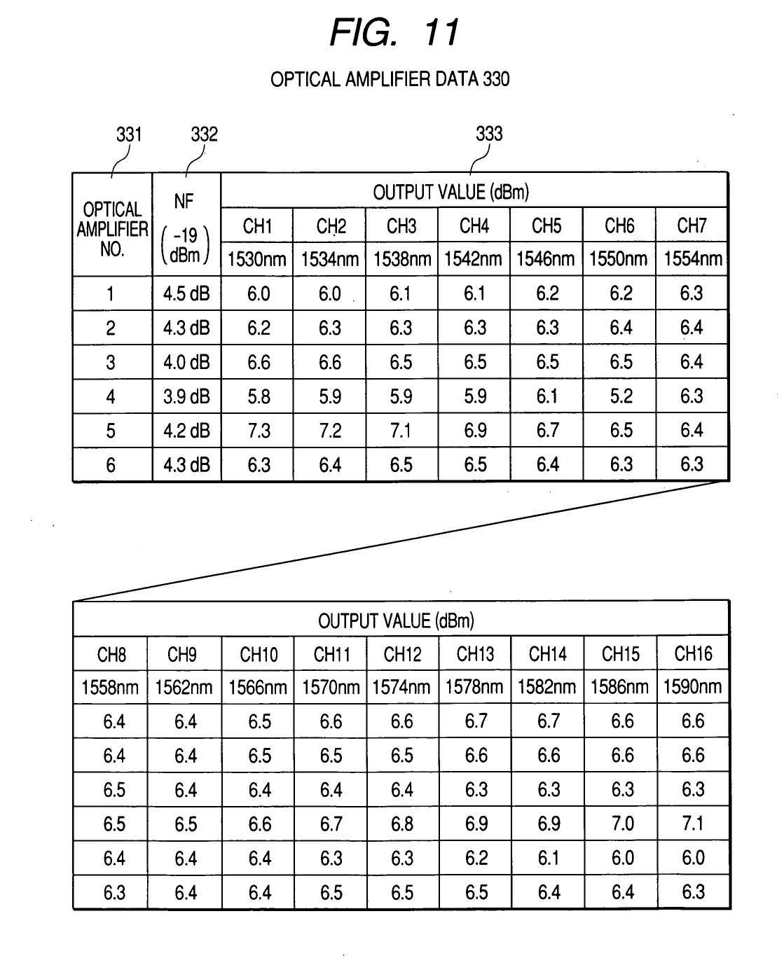

FIG. 11 shows an example of optical amplifier data 330 read out from the equipment data file 30 into the optical amplifier data file region 33.

The optical amplifier data 330 shows a relationship between a noise factor NF 322 and each of output signal values 333 in different channels CH1 (at a wavelength of 1530 nm) to CH16 (at a wavelength of 1500 nm) when an input to the optical amplifier is a reference value (which is −19 dBm herein), in correspondence to optical amplifier type numbers 331. As the noise factor NF is lower, signal deterioration due to noise occurring in the optical amplifier is reduced and the transmission distance of an optical signal can be elongated. The output signal value (output level) 333 indicates the wavelength dependence of the amplifier portion 810 shown in FIG. 6. Although the optical amplifiers of different types have different gain slopes, these gain slopes are compensated for by the additional gain slope compensator 811 attached to the amplifier 810.

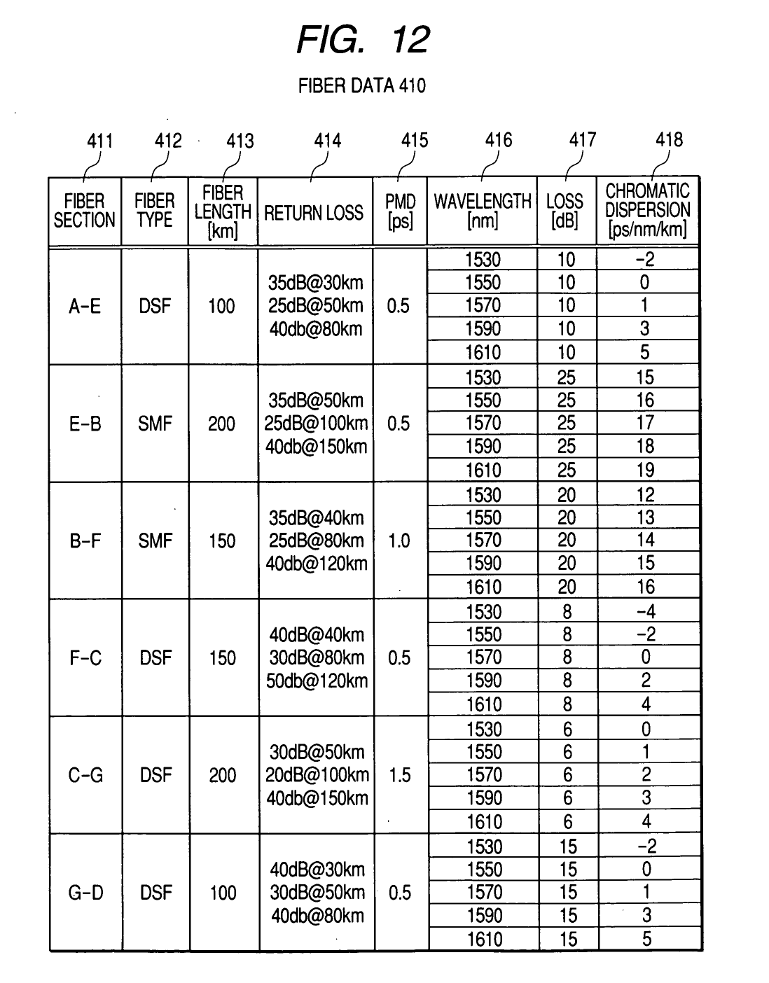

FIG. 12 shows an example of fiber data 410 read out from the fiber data file 40 into the fiber data file region 41.

The fiber data 410 indicates, in correspondence with an optical fiber section 411, a fiber type 412, a fiber length 413, a return loss 414, a PMD 415 indicative of a total amount of polarization dispersion occurring in this fiber, an amount of optical loss 417 occurring at a wavelength 416, and an amount of chromatic dispersion 418 occurring at the wavelength 416.

Here, the optical fiber section 411 is specified by site names positioned at both ends of each of the fiber sections. For example, A-E corresponds to the fiber S1 installed between the sites A and E in FIG. 5 and E-B corresponds to the fiber S2 installed between the sites E and B in FIG. 5.

As the fiber types 412, there can be listed, e.g., DSF, NZDSF, SMF, and the like which are greatly different in characteristic from each other. In general, the SMF has large chromatic dispersion so that four wave mixing which is a non-linear effect serving as a signal deterioration factor is less likely to occur. Accordingly, the SMF is suited to high-density wavelength division multiplexing involving a larger number of wavelengths but it requires a large-scale chromatic dispersion compensating module. The DSF has smaller chromatic dispersion so that a small-scale chromatic dispersion compensating module is sufficient.

However, high-density wavelength division multiplexing is difficult because four wave mixing readily occurs. The NZDSF has characteristics intermediate between the SMF and the DSF. Thus, the fiber type allows judgment of whether or not the section is suited to wavelength division multiplexing.

In the case of using a dark fiber, the fiber length 413 indicates a fiber length measured by using, e.g., an optical time domain reflectometer (OTDR) or the like. By calculating an amount of loss per unit distance (which is, e.g., 1 km) from the fiber length 413 and the loss 407, the degradation of the fiber can be estimated. For example, if the loss per kilometer is remarkably large, contamination on a fiber coupler (connector portion) or the like can be considered as a cause so that the inspection and cleaning of the portion in question becomes necessary.

The return loss 414 indicates an amount of attenuation resulting from optical return occurring at the fiber coupler or a bent portion of the fiber measured by using the OTDR or the like and a distance from a fiber starting point to the measured portion. If the return loss is large, the cleaning of the fiber coupler or the correction of the bent portion becomes necessary as a countermeasure against it. A total amount of polarization dispersion indicated by the PMD 415 becomes a signal deterioration factor particularly during high-speed transmission at 10 Gbit/s or more so that, if the RMD has a high value, it is necessary to change the currently used fiber to another fiber smaller in polarization dispersion.

The loss 417 becomes a factor causing optical signal deterioration. Since the optical amplifier 81 has fixed output levels at different wavelengths, the loss occurring in the input-side optical fiber varies the gain of the optical amplifier and affects the gain deviation of an output from the amplifier. Moreover, since the loss occurring in the optical fiber also has wavelength dependence, it is necessary to perform simulation in consideration of the gain of the optical amplifier and losses occurring in input signals at different wavelengths so that gain flatness is retained. Furthermore, chromatic dispersion indicated by the chromatic dispersion 418 should be corrected by using a chromatic dispersion compensating module since the chromatic dispersion becomes a signal deterioration factor.

In the process of acquiring the fiber data, if it is judged from the return loss and the amount of loss that the coupler should be cleaned or the bent portion should be corrected, a repair treatment needed is performed in the field and the measurement is repeated again. The fiber data 410 read into the data region 41 indicates a measured value in each of the optical fiber sections after the above repair treatment is performed.

In an optical network constructed by connecting optical fibers in a plurality of sections in cascade by using repeater equipment, if an excessive loss has occurred even in one section thereof, an S/N ratio deteriorates significantly in the section so that the entire optical network is critically impaired. However, since the present invention actually measures characteristic data on each of fibers used for the optical network, if the measured value of the optical loss is abnormally high, a proper improvement measure can be taken immediately for the impaired fiber. Further more, since the configuration of the repeater equipment is determined based on the characteristic data on the optical fibers from which such an impairment has been removed, the operation of constructing the optical network performed subsequently in the field is significantly facilitated.

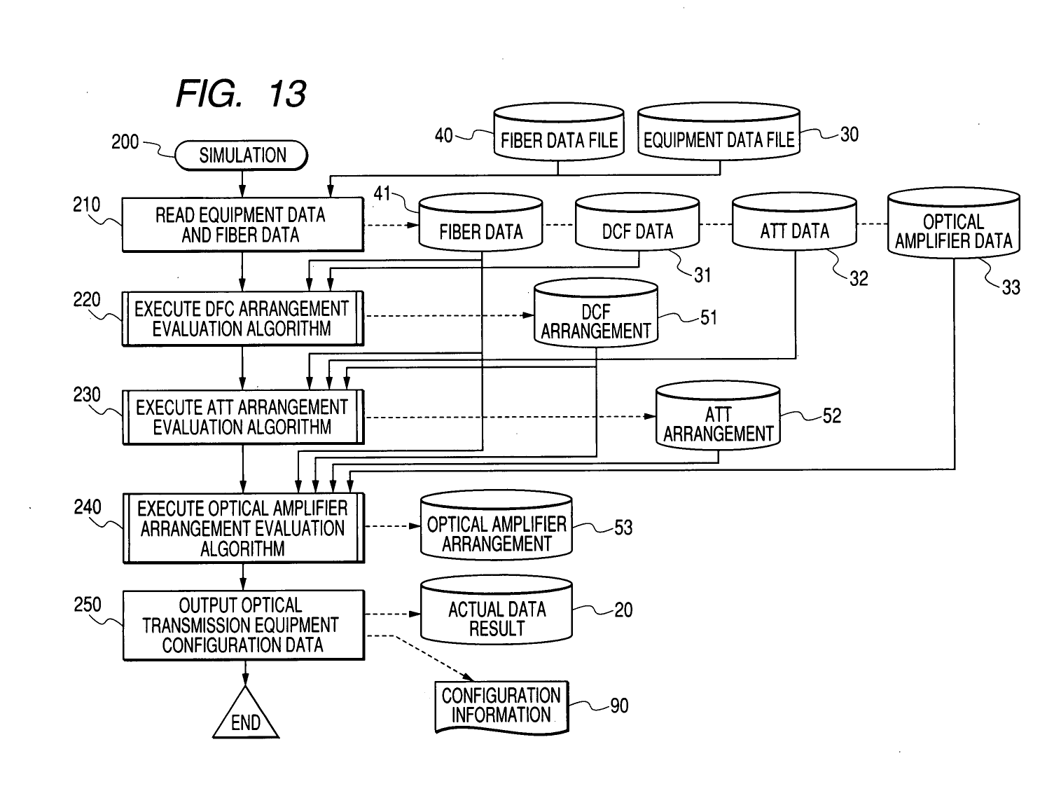

FIG. 13 shows a flow chart illustrating an embodiment of the simulation program 200 executed by the processor 11.

The simulation program 200 first reads out the respective contents of the equipment data file 30 and the fiber data file 40 into the data memory 14 and creates the PCF data file 31, the ATT data file 32, the optical data file 33, and the fiber data file 41 (Step 210).

Then, the simulation program 200 executes the DCF arrangement evaluation algorithm 220, the ATT arrangement evaluation algorithm 230, and the optical amplifier arrangement evaluation algorithm 240 in succession and finally executes the actual data management routine 250. The configuration data on the optical transmission system obtained as the result of simulation is print outputted for use in the installation operation, while it is registered in the actual data file 20.

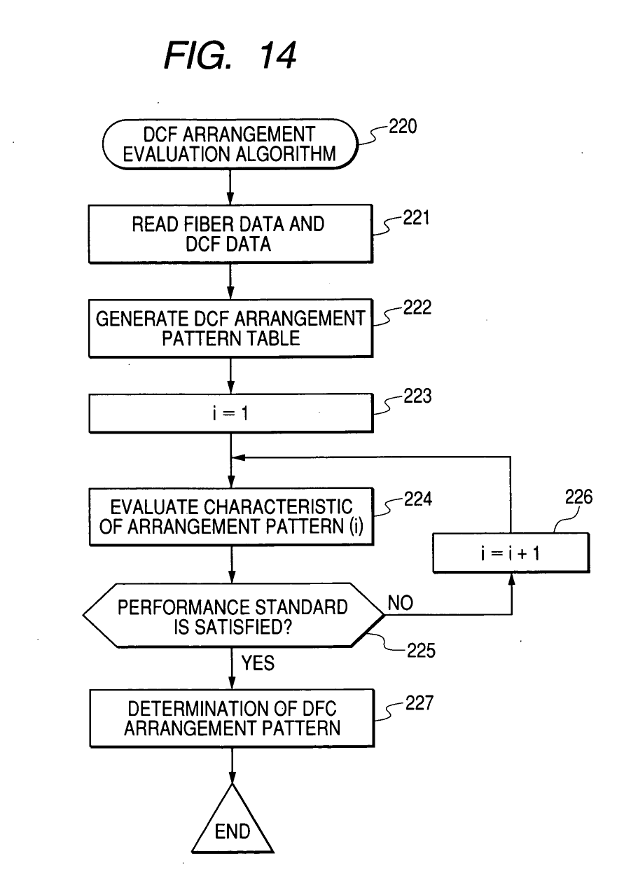

In the DCF arrangement evaluation algorithm 220, as shown in FIG. 14, the DCF data and the fiber data are read out from the file regions 31 and 41 of the data memory 14 (Step 221) and a DCF arrangement pattern table 510 comprising of a plurality of DCF arrangement patters is created by varying the combination of DCFs to be arranged on the boundaries (sites) between the optical fiber sections 4.11 (222).

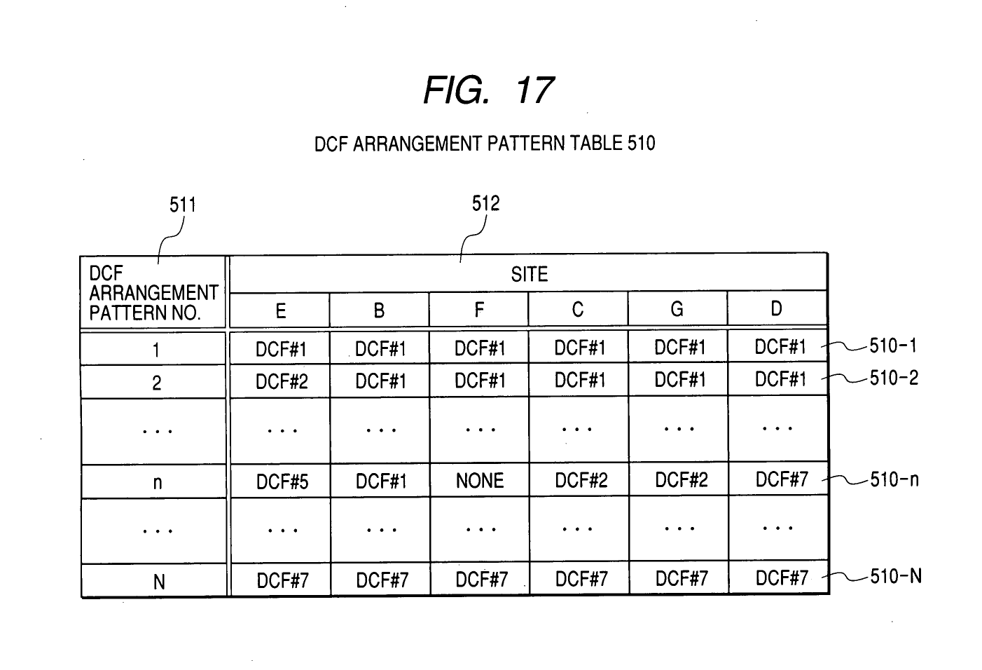

In the case of constructing, e.g., an optical network composed of the optical fibers S1 to S6 shown in FIG. 5, the DCF arrangement pattern table 510 created here is composed of N entries 510-1 to 510-N each having an arrangement pattern number 511, as shown in FIG. 17. Each of the entries represents the types 512 of the DCFs arranged at the respective sites E to D on the optical fibers S1 to S6 and the combination of DCFs differs for each entry.

The arrangement pattern of the entry 510-1 indicates to place DCFs of the type number 1 (Chromatic Dispersion Compensation Value=−100 ps/nm) at all the sites. The arrangement pattern of the entry 510-N indicates to place DCFs of the type number N (Chromatic Dispersion Compensation Value=200 ps/nm) at all the sites. The entry 510-n indicates a DCF arrangement pattern in which the DCF placement is omitted at the site F.

After the creation of the DCF arrangement pattern table 510, the value of a parameter i for specifying an entry as a simulation target is set (223) to an initial value of 1, the effect of compensating for chromatic dispersion when the DCFs are arranged at the sites E to D according to the arrangement pattern (i) is simulated, and the performance thereof is evaluated (224). From the result of the simulation, it is judged whether or not predetermined performance standards such as an optical S/N ratio, waveform distortion, and the like are satisfied between the both ends of the optical network (225).

If the arrangement pattern (i) cannot satisfy the performance standards, the value of the parameter i is incremented (226) and the program sequence returns to Step 224 to repeat the simulation with the next arrangement pattern. If the placement pattern (i) satisfies the performance standards, the DCF arrangement pattern is determined (227). In this case, a relationship between each the sites E to D and the DCF type to be arranged, which is indicated by the arrangement pattern (i), is stored as the DCF arrangement result data in the region 51 of the memory 15, whereby the DCF arrangement evaluation algorithm is completed.

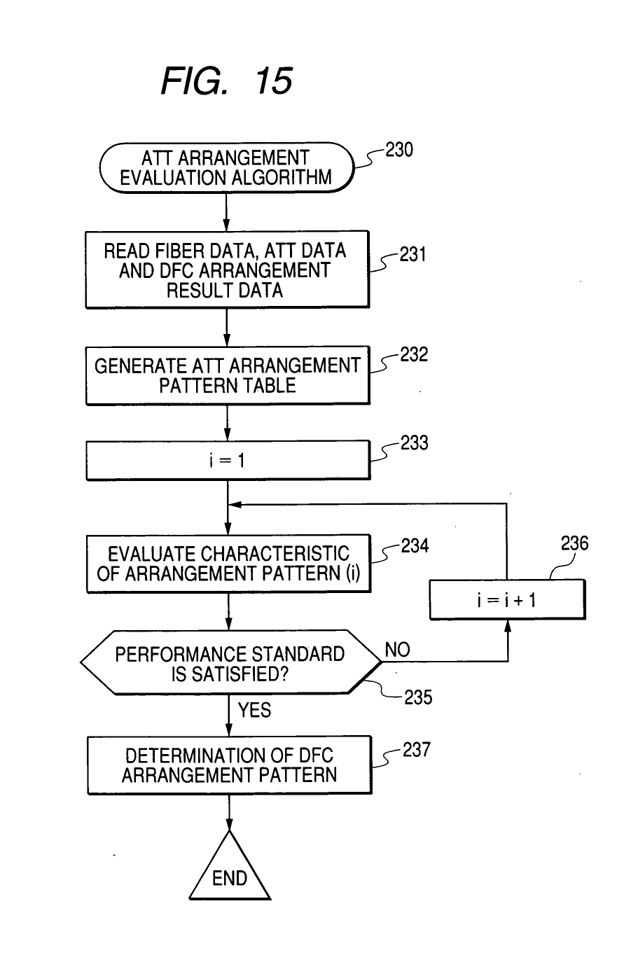

As shown in FIG. 15, the ATT arrangement evaluation algorithm 230 reads out the ATT data and the fiber data from the file regions 32 and 41 of the memory 14 and reads out the DCF arrangement result data from the region 51 of the memory 15 (step 231).

Next, an ATT arrangement pattern table including a plurality of ATT arrangement pattern entries is created by varying the combination of ATTs to be arranged on the boundary portions (sites) between the optical fiber sections 411, similarly to the DCF arrangement pattern table (232). However, the final site D at which the regenerative repeater equipment is placed is excluded from the target of ATT arrangement.

Next, the value of the parameter i for specifying the entry as the simulation target is set (233) to the initial value of 1, the effect of adjusting the optical signal when the ATTs are arranged at the individual sites according to the arrangement pattern (i) is simulated, and the performance thereof is evaluated (234). For an ATT simulation model, the effect of DCF insertion on an input optical signal using the DCF arrangement result data in addition to the optical fiber data is considered.

The result of the simulation is judged (235). If specified performance standards are satisfied between the both ends, the ATT arrangement pattern is determined (237) and a relationship between each of the sites E to D and the ATT type, which is indicated by the arrangement pattern (i), is stored as ATT arrangement result data in the region 52 of the memory 15, whereby the ATT arrangement evaluation algorithm is completed. If the standards are not satisfied by the arrangement pattern (i), the value of the parameter i is incremented (236) and the program sequence returns to Step 234 to repeat the simulation for the next arrangement pattern.

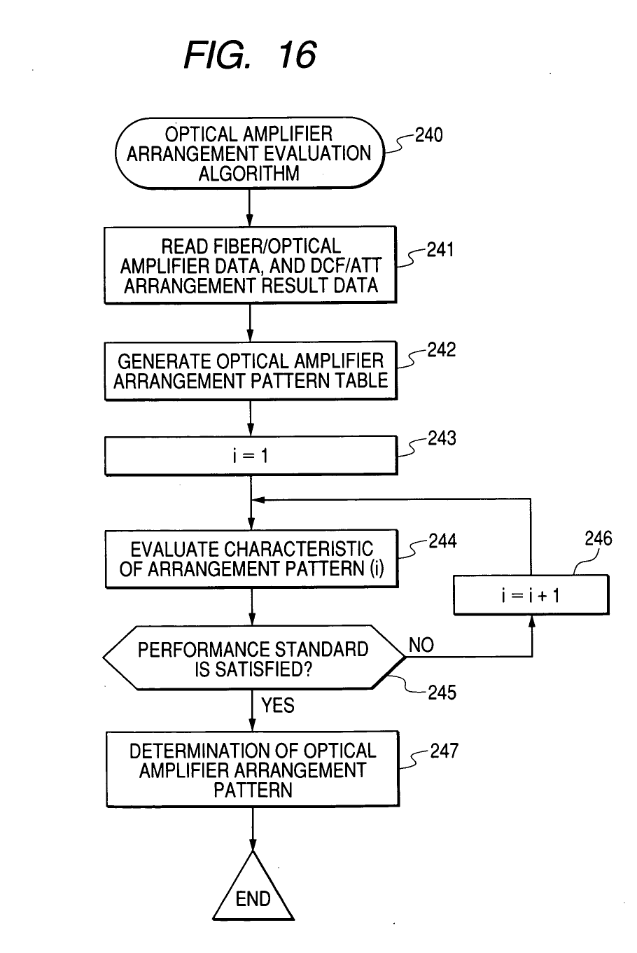

As shown in FIG. 16, the optical amplifier arrangement evaluation algorithm 240 reads out the optical amplifier data and the fiber data from the file regions 33 and 41 of the memory 14 and reads out the DCF arrangement result data and the ATT arrangement result data from the regions 51 and 52 of the memory 15 (step 241). Next, an optical amplifier arrangement pattern table including a plurality of optical amplifier arrangement pattern entries is created (242) by varying the combination of the kinds (types) of optical amplifiers for each entry, for the optical amplifiers to be arranged on the boundary portions (sites) between the optical fiber sections 411. For the final site D, an optical amplifier to be placed is selected from a group of optical amplifiers prepared for use in regenerative repeater equipment.

Next, the value of the parameter i for specifying the entry as the target simulation is set (243) to an initial value of 1, the optical signal output when the optical amplifiers are arranged at the individual sites according to the arrangement pattern (i) is simulated, and the performance thereof is evaluated (244). For the simulation of optical amplifiers, an optical signal output from each of the optical amplifiers is simulated by using the DCF arrangement result data and the ATT arrangement result data in addition to the optical fiber data and by considering the effect of inserting DCFs and ATTs on an input optical signal.

The result of the simulation is judged (245). If specified performance standards are satisfied between the both ends, the optical amplifier arrangement pattern is determined (247) and a relationship between each of the sites E to D and the optical amplifier type, which is indicated by the arrangement pattern (i), is stored as optical amplifier arrangement result data in the region 53 of the memory 15, whereby the optical amplifier arrangement evaluation algorithm is completed. If the standards are not satisfied by the arrangement pattern (i), the value of the parameter i is incremented (246) and the program sequence returns to Step 244 to repeat the simulation for the next arrangement pattern.

Finally, in Step 250 of FIG. 13, the DCF arrangement result data, the ATT arrangement result data, and the optical amplifier arrangement result data stored in the memory 15 as a result of the simulation are added to the actual data file in association with the fiber data 400. In addition, the network configuration information 90 specifying the DCFs, the ATTs, and the optical amplifiers to be arranged at the individual sites is print outputted.

In the embodiment, the feature of the present invention resides in that it previously prepares the patterns for the arrangement of parts at the plurality of sites in the arrangement pattern tables and determines whether or not specified performance standards are satisfied between the both ends as a result of simulation using each of the arrangement patterns. In short, the present invention is characterized by the finding, by simulation, a part arrangement pattern in which a received optical signal satisfies objective standards at the final site D on the network of FIG. 5. Accordingly, the achievement of the objective standards at each of the sites E to G in the middle of the network to be constructed is not an indispensable condition.

According to a conventional simulation technique, it is common practice in the case of, e.g., determining optical line amplifier equipment (or parts) to be placed at each of the sites, to successively apply plural types of selectable optical line amplifier equipment to the first site, determine the correspondence of the optical line amplifier equipment which satisfies performance standards, and successively determine the type of the optical line amplifier equipment which satisfies the performance standards for each of the remaining sites in the same procedure.

In this case, simulation is performed at each of the sites without considering the characteristics of the subsequent optical fibers and the remaining sites. Since optical amplifier equipment is constructed for each of the sites with a view to completely compensating for an optical loss occurring and signal distortion resulting from dispersion in each of the fiber sections, if the objective performance cannot be achieved at a site in the middle of the network section to be constructed, regenerative repeater equipment has to be placed at the site in the resultant network configuration. There are also cases where an actually constructed network does not show performance as simulated because simulation errors at the individual sites on a signal path cumulatively appear at the final site.

By contrast, the present invention performs simulation in the state in which parts are arranged at all the sites in accordance with the part arrangement pattern and determines whether or not the end-to-end signal, i.e., the received optical signal at the final site satisfies objective standards. Accordingly, the output optical signal need not necessarily achieve the objective standards at each of the sites in the middle of the network to be constructed. Even when, e.g., chromatic dispersion of a level which cannot sufficiently be compensated for by a DCF has occurred at a site in the middle of the network to be constructed, if chromatic dispersion occurring in the latter half of the network is small, the dispersion value appearing in the received optical signal at the final site can be brought within the range of the objective standards by chromatic dispersion compensation using the DCFs at the subsequent sites.

If all the assumed part arrangement patterns cannot satisfy the objective standards in the arrangement evaluation algorithms 220 to 240 for the DCFs, the ATTs, and the optical amplifiers, it indicates that the construction of all the end-to-end transmission equipment items using the optical line amplifier equipment items is impossible with given optical fibers and transmission equipment parts. In this case, regenerative repeater equipment is placed at a site located midway in the optical network section to be constructed or at a specified site requested by a client, the optical network is divided into two sub-networks by regarding the site as one end terminal, and the simulation program 200 is performed again by regarding each of the sub-networks as a design target.

Although the embodiment shown in FIG. 1 has determined the types of the parts to be arranged at the individual sites in the order of the DCFs, the fine adjustment parts (ATTs), and the optical amplifiers, it is also possible to determine the arrangement of the fine adjustment parts and then determine the arrangement of the DCFs. In that case, the DCF arrangement evaluation algorithm performs simulation in consideration of the effect of inserting the fine adjustment parts and determines the types of DCFs to be arranged at the individual sites.

When the transmission equipment is placed at each of the sites in accordance with the result of simulation and the normal operation of the network system is checked, it is recorded in the actual data file 20 that the result of the current session of simulation is valid. If an adjustment operation is needed at each of the sites, the contents of the adjustment operation is registered in the actual data file 20 in association with the result of simulation so that it is reflected on the next design.

As is obvious from the foregoing description, according to the present invention, the configuration of the transmission equipment to be placed at each of the sites is determined through simulation by using data measured from the components of the network. By thus placing the transmission equipment at each of the sites in accordance with the result of the simulation, it becomes possible to rapidly construct the optical network.

Since optimum arrangement of the parts is determined by performing simulation with the components of the transmission equipment (optical line amplifier equipment) being arranged at all the sites on the optical network and evaluating the end-to-end state of the optical signal, even if objective performance cannot be achieved at any of the middle sites, a practical optical network system can be constructed which reaches an excellent signal state at the final stage. This allows an inter-repeater distance to be extended by using the optical line amplifier equipment.

In the case of constructing the optical network by using dark fibers, a repair operation such as the cleaning of a connector portion or the correction of a bent portion is performed with respect to a faulty portion detected on a survey so that the fiber characteristic data is acquired in the state without trouble and used for simulation, as described in the embodiment. This allows further extension of the inter-repeater distance using the optical line amplifier equipment and prevention of trouble.

As is obvious from the foregoing embodiment, the present invention has determined the configuration of each of the sites by using data measured from the components of the network and considering all the sites on the optical network to be constructed in perspective. This allows the extension of the inter-repeater section using the optical line amplifier equipment and the provision of the optical network with a reduced number of regeneration repeater sites. Further more, since preliminary simulation allows the disclosure of the configuration of the repeater equipment to be placed at each of the sites, the operation of placing the repeater equipment can be performed promptly and precisely in the field.

1. A method for constructing an optical network system composed of optical fibers in a plurality of sections and repeater equipment placed at each of sites located on boundaries between the sections, said method comprising:
a step of accumulating, in a first memory, measured characteristic survey data on the optical fibers to be installed in said individual sections as fiber data associated with the sections;
a step of accumulating, in a second memory, measured characteristic survey data on plural kinds of parts serving as components of the repeater equipment, preparing a plurality of types having different characteristics for each of the kinds of parts, as part data corresponding to the respective kinds of parts; and
a simulation step of selecting the parts to be arranged at each of the sites on the optical network composed of said optical fibers in the plurality of sections by simulation performed on a computer by using the fiber data accumulated in said first memory and the part data accumulated in said second memory to determine a configuration of the repeater equipment placed at each of the sites.

2. A method for constructing an optical network system according to claim 1, wherein
characteristic data on an optical amplifier, an optical attenuator, and a chromatic dispersion compensating module, each having a plurality of types, is accumulated in said second memory and
the configuration of optical line amplifier equipment serving as said repeater equipment to be placed at each of the sites is determined in said simulation step.

3. A method for constructing an optical network system according to claim 1, wherein said simulation step includes:
generating a plurality of part arrangement patterns representing the parts to be arranged at the plurality of sites on the optical network by varying, on a per part kind basis, a combination of the types of parts to be used and
simulating a state of an optical signal when the parts are arranged at each of said sites according to each of the arrangement patterns and selecting, on a per part kind basis, that one of the part arrangement patterns which satisfies a given signal standard at a terminal end of the optical fiber in the final section to determine the configuration of the repeater equipment placed at each of the sites.

4. A method for constructing an optical network system according to claim 2, wherein said simulation step includes:
generating a plurality of part arrangement patterns representing the parts to be arranged at the plurality of sites on the optical network by varying, on a per part kind basis, a combination of the types of parts to be used, and
simulating a state of an optical signal when the parts are arranged at each of said sites according to each of the arrangement patterns and selecting, on a per part kind basis, that one of the part arrangement patterns which satisfies a given signal standard at a terminal end of the optical fiber in the final section to determine the configuration of the repeater equipment placed at each of the sites.

5. A method for constructing an optical network system according to claim 1, further comprising:
a step of outputting, as optical network configuration information, a relationship between each of said sites and the configuration of the repeater equipment to be placed thereat determined in said simulation step.

6. A method for constructing an optical network system according to claim 2, further comprising:
a step of outputting, as optical network configuration information, a relationship between each of said sites and the configuration of the repeater equipment to be placed thereat determined in said simulation step.

7. A method for constructing an optical network system according to claim 3, further comprising:
a step of outputting, as optical network configuration information, a relationship between each of said sites and the configuration of the repeater equipment to be placed thereat determined in said simulation step.

8. A system for supporting construction of an optical network system composed of optical fibers in a plurality of sections and repeater equipment placed at each of sites located on boundaries between the sections, said system comprising:
a first memory for accumulating measured characteristic survey data on the optical fibers to be installed in said individual sections as fiber data associated with the sections;
a second memory for accumulating measured characteristic survey data on plural kinds of parts serving as components of the repeater equipment, preparing a plurality of types having different characteristics for each of the kinds of parts, as part data corresponding to the respective kinds of parts;
a data processor for selecting the parts to be arranged at each of the sites on the optical network composed of said optical fibers in the plurality of sections by executing a simulation program using the fiber data accumulated in said first memory and the part data accumulated in said second memory to determine a configuration of the repeater equipment placed at each of the sites; and
an output device for outputting, as optical network configuration information, a relationship between each of said sites and the repeater equipment to be placed thereat obtained as a result of the simulation.
